(19) United States
(12) Patent Application Publication
(10) Pub. No.: US 2009/0272318 A1
(43) Pub. Date: Nov. 5, 2009

(54) Device for supporting a substrate, as well as a method for manufacturing such a device

(75) Inventors: Willem Pieter Van Duijn, Helmond (NL); Carolus Wilhelmus Pas, Helmond (NL)

Correspondence Address: Haynes and Boone, LLP;IP Section, 2323 Victory Avenue, SUITE 700, Dallas, TX, 75219, US

(73) Assignee: XYCARB CERAMICS B.V., CS HELMOND (NL)

(21) Appl. No.: 11/919,324

(22) PCT Filed: Apr. 26, 2006
(86) PCT No.: PCT/NL2006/000226

§ 371 Date: Oct. 25, 2007

(30) Foreign Application Priority Data
Apr. 26, 2005 (NL) 1028867

(51) Int. Cl. B05C 13/00; C23F 1/00

(52) U.S. Cl. 118/500; 216/37

(57) ABSTRACT

The invention to a device (10) for supporting a substrate during the manufacture of semiconductor components, comprising a substantially flat plate with an upper surface (11) on which the substrate can be positioned. The invention also relates to a method for manufacturing such a device (10). The object of the invention is to provide a device (10) according to the preamble, which is of inexpensive and simple construction but which also allows the passage of a process gas in the direction of the substrate under certain manufacturing conditions, for example for supplying a protective gas to the substrate or having the substrate rest on an air cushion. According to the invention, the upper surface (11) of the plate is at least partially porous (14). Thus, costly and extremely precise machining of the device (10), as usually required in the current state of the art, is unnecessary, thereby making it possible to manufacture the device (10) at much lower cost.

The invention relates to a device for supporting a substrate during the manufacture of semiconductor components, comprising a substantially flat plate with an upper surface on which the substrate can be positioned.

The invention also relates to a method for manufacturing such a device.

Such a device is shown in European patent publication No. 0683505, for example. The device or susceptor described in said patent specification is provided with a pattern made up of one or more or grooves as well as openings in the upper surface thereof, through which grooves and openings a process gas can be passed under the substrate that is present on the device.

The grooves and the openings for the process gas have been machined in the upper surface, for example by means of a drilling or milling technique. This leads to a costly and, in addition, complex construction.

The object of the invention is to provide a device according to the preamble, which is of inexpensive and simple construction but which also allows the passage of a process gas in the direction of the substrate under certain manufacturing conditions, for example for supplying a protective gas to the substrate or having the substrate rest on an air cushion.

According to the invention, the upper surface of the plate is at least partially porous. Thus, costly and extremely precise machining of the device, as usually required in the current state of the art, is unnecessary, thereby making it possible to manufacture the device at much lower cost.

According to a further aspect of the device according to the invention, the upper surface contains at least partially porous metal carbide.

The porosity of the upper surface can be adjusted in that case by etching away at least metal molecules, whilst more in particular the porosity of the upper surface can also be adjusted by etching away at least metal carbide molecules.

Experiments have shown that a functional embodiment of the device can be obtained if the porosity ranges between 5 vol. % and 90 vol. %.

In a specific embodiment according to the invention, the device is made up of a composite composed of a carbon core and an outer layer of metal carbide.

More in particular, said metal carbide is silicon carbide.

According to the invention, the method for manufacturing a device for supporting a substrate during the manufacture of semiconductor components comprises at least the steps of:

A supplying a carbon core;
B applying a layer of metal carbide to the carbon core;
C making the layer of metal carbide at least partially porous by at least partially etching away metal molecules.

More specifically, the method is further characterised by the step of

D making the layer of metal carbide at least partially porous by at least partially etching away metal carbide molecules.

The invention will now be explained in more detail with reference to a drawing, in which:

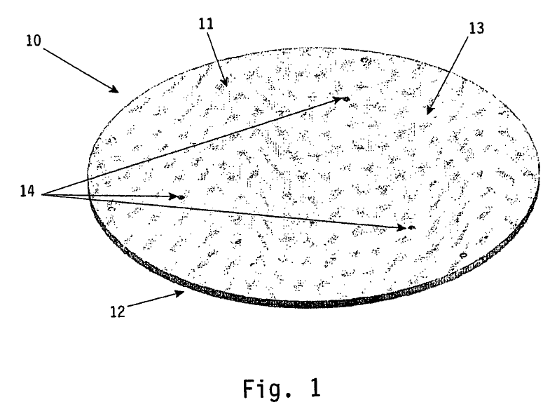

FIG. 1 is a cross-sectional view of an embodiment of a susceptor according to the invention;

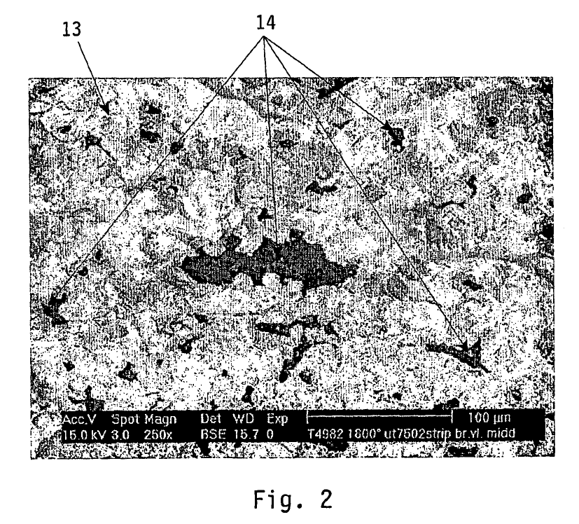

FIG. 2 is a photo that shows the material of a susceptor according to the invention prior to the etching operation for obtaining a porous structure;

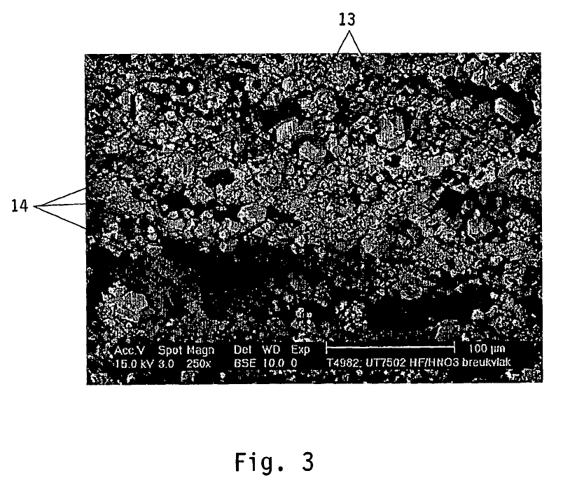

FIG. 3 is a photo that shows the material of a susceptor according to the invention after the etching operation for obtaining a porous structure.

FIG. 1 shows in top view a susceptor according to the invention. The susceptor 10 functions as a device for supporting a substrate during the manufacture of semiconductor components and comprises a substantially flat plate 10 having a lower surface 12 and an upper surface 11. The substrate is positioned on said upper surface 11 during the manufacturing steps of the semiconductor components.

The susceptor 10 is at least partially made of a metal carbide material 13, and more in particular the upper surface 11 is at least partially made of metal carbide.

According to the invention, the substrate is at least partially porous, and more in particular the upper surface 11 of the susceptor is at least partially porous. This leads to porous openings 14 obtained by etching away at least metal carbide molecules from which the upper surface 11, and more in particular the susceptor, Is made. See FIGS. 2 and 3, which show the material of the susceptor according to the invention prior to and after the etching operation, respectively.

More specifically, the susceptor is made up of a composite, which is composed of a carbon core and an outer layer of metal carbide. The porosity of at least the upper surface of the susceptor can be adjusted by etching away at least metal carbide molecules or by etching away at least metal molecules.

More specifically, the porosity ranges between 5 vol. % and 90 vol. %.

The porous nature of the susceptor makes it possible to supply a process gas at the bottom side, which process gas is passed through the porous channels in the susceptor to the upper surface 11 on which the substrate (not shown) is positioned. By supplying a process gas or, for example, a protective gas to the substrate, said substrate can be positioned on an air cushion, for example, which is desirable under certain manufacturing conditions of semiconductor components.

When the susceptor according to the invention is used it is no longer necessary to subject the susceptor according to the prior art to costly and extremely precise machining operations, which operations are required with the susceptors that are currently being used in the semiconductor industry. The susceptor according to the invention is easier to manufacture, the more so because the porosity of the susceptor, and in particular of the upper surface thereof, is adjustable.

1. (canceled)

2. (canceled)

3. (canceled)

4. (canceled)

5. (canceled)

6. (canceled)

7. (canceled)

8. (canceled)

9. (canceled)

10. A device for supporting a substrate during the manufacture of semiconductor components, comprising a substantially flat plate with an upper surface on which the substrate can be positioned, characterised in that the upper surface of the plate is at least partially porous.

11. A device according to claim 10, characterised in that the upper surface contains at least partially porous metal carbide.

12. A device according to claim 11, characterised in that the porosity of the upper surface can be adjusted by etching away at least metal molecules.

13. A device according to claim 11, characterised in that the porosity of the upper surface can be adjusted by etching away at least metal carbide molecules.

14. A device according to claim 10, characterised in that the device is made up of a composite composed of a carbon core and an outer layer of metal carbide.

15. A device according to claim 10, characterised in that the porosity ranges between 5 vol. % and 90 vol. %.

16. A device according to claim 10, characterised in that the said metal carbide is silicon carbide.

17. A method for manufacturing a device for supporting a substrate during the manufacture of semiconductor components, comprising at least the steps of:
supplying a carbon core;
applying a layer of metal carbide to the carbon core; and
making the layer of metal carbide at least partially porous by at least partially etching away metal molecules.

18. A method according to claim 17, further characterised by the step of making the layer of metal carbide at least partially porous by at least partially etching away metal carbide molecules.
